(19) United States
(12) Patent Application Publication
(10) Pub. No.: US 2026/0121955 A1
(43) Pub. Date: Apr. 30, 2026

(54) Multi-Homed Host Tracking

(71) Applicant: Cisco Technology, Inc., San Jose, CA (US)

(72) Inventors: Mankamana Prasad Mishra, San Jose, CA (US); Nitin Kumar, San Jose, CA (US); Swadesh Agrawal, Fremont, CA (US); Sameer R. Gulrajani, Fremont, CA (US); Ali Sajassi, Alamo, CA (US)

(21) Appl. No.: 18/933,752

(22) Filed: Oct. 31, 2024

(51) Int. Cl. H04L 43/0811; H04L 49/354; H04L 61/251

(52) U.S. Cl. CPC H04L 43/0811; H04L 49/354; H04L 61/251

(57) ABSTRACT

Devices, networks, systems, methods, and processes for tracking a multi-homed host device are provided herein. A communication network may include at least two network devices and a host device that is multi-homed to the at least two network devices. A network device of the at least two network devices transmits a first tracking request to the host device and receives a tracking response for the first tracking request at a network-side interface of the network device. The first tracking request includes a first data sequence. The network device transmits, based on receiving the tracking response at the network-side interface, one or more second tracking requests with varying second data sequences in an attempt to force a response from the host device at a host-side interface of the network device. Thus, the host device is tracked in an efficient manner without changing a hashing algorithm of the host device.

The present disclosure relates to communication networks. More particularly, the present disclosure relates to tracking a multi-homed host device in the communication networks.

### BACKGROUND

Ethernet virtual private network (EVPN) is commonly utilized in network deployments, with EVPN-based all-active multi-homing emerging as a fundamental building block of next-generation network deployment. Specifically, this approach is utilized in data center deployments and service provider access/aggregation networks. In numerous EVPN deployments, host devices are shielded behind all-active multi-homing segments. These host devices are connected to multiple network devices to provide redundancy and ensure high network availability and reliability. Typically, the host devices support networking functions that serve as next hops to various applications deployed on servers. However, these networking functions can fail to operate due to software issues, resulting in the inability to access the applications on the servers. This underscores the importance of tracking these host devices and the networking functions.

Currently, various methods are available to track a multi-homed host device. These methods involve initiating a request from one network device to the host device and awaiting a response. However, in an all-active redundancy mode, the host device can transmit the response to a different network device in a multi-homing set instead of the original sender. This creates a problem, as the original sender is left unaware of which network device received the response. Consequently, the original sender may mark the host device as inactive, leading to potential false alerts. This lack of awareness can cause inefficiencies and gaps in network monitoring and tracking, as the original sender is unable to perform necessary actions based on the host's response.

### SUMMARY OF THE DISCLOSURE

Systems and methods for tracking a multi-homed host device in communication networks in accordance with embodiments of the disclosure are described herein.

In many embodiments, a network device comprises a network-side interface, a host-side interface, a processor, and a memory communicatively coupled to the processor. The memory comprises a tracking logic that is configured to transmit, to a host device via the host-side interface, a first tracking request including a first data sequence, receive, at the network-side interface, a tracking response for the transmitted first tracking request, and generate one or more second tracking requests based on receiving the tracking response at the network-side interface. Each of the one or more second tracking requests includes a second data sequence that is different from the first data sequence. The tracking logic is further configured to transmit the generated one or more second tracking requests to the host device via the host-side interface.

In a variety of embodiments, the tracking logic is further configured to track, based on the first tracking request and the one or more second tracking requests, a virtual network function associated with the host device, and determine a status of the virtual network function as one of an active state or an inactive state based on the tracking.

In a number of embodiments, the virtual network function corresponds to a virtual network forwarder (VNF).

In further embodiments, the tracking logic is further configured to receive, at the host-side interface, a new tracking response for a second tracking request of the one or more second tracking requests, and designate the second data sequence of the second tracking request as an active data sequence for one or more subsequent tracking requests.

In more embodiments, the first tracking request and the one or more second tracking requests are associated with a response timeout parameter.

In several embodiments, the tracking logic is further configured to set a new response timeout parameter for the one or more subsequent tracking requests based on the response timeout parameter.

In numerous embodiments, the new response timeout parameter is smaller than the response timeout parameter.

In various embodiments, the first tracking request and the one or more second tracking requests correspond to bidirectional forwarding detection (BFD) requests.

In one or more embodiments, the first data sequence includes a plurality of data parameters. To generate a second tracking request of the one or more second tracking requests, the tracking logic is further configured to sample, from the plurality of data parameters, at least one data parameter based on receiving the tracking response at the network-side interface, and modify the at least one data parameter to obtain at least one modified data parameter. The second data sequence of the second tracking request includes the at least one modified data parameter.

In still more embodiments, the plurality of data parameters includes two or more of: an internet protocol (IP) address of the network device, an IP address of the host device, a media access control (MAC) address of the network device, or a MAC address of the host device.

In yet more embodiments, the host-side interface is communicatively coupled to the host device via a single-hop connection.

In still yet more embodiments, the network-side interface is communicatively coupled to the host device via a multi-hop connection.

In many further embodiments, the network device is a member of a multi-homing set coupled to the host device.

In yet many embodiments, a network device comprises a network-side interface, a host-side interface, a processor, and a memory communicatively coupled to the processor. The memory comprises a tracking logic that is configured to establish a first tracking session with a host device, wherein the first tracking session is associated with a first data sequence, receive, in the first tracking session, a tracking response of the host device at the network-side interface based on the first data sequence, and establish, based on receiving the tracking response at the network-side interface, a second tracking session with the host device. The second tracking session is associated with one or more second data sequences that are different from the first data sequence.

In several more embodiments, the tracking logic is further configured to receive, in the second tracking session, a new tracking response of the host device at the host-side interface, and designate the second tracking session as an active tracking session based on receiving the new tracking response at the host-side interface.

In several additional embodiments, the first tracking session is associated with a response timeout parameter. The tracking logic is further configured to set a new response timeout parameter for the second tracking session in response to designating the second tracking session as the active tracking session.

In numerous additional embodiments, the new response timeout parameter is smaller than the response timeout parameter.

In yet several embodiments, the tracking logic is further configured to deactivate the first tracking session based on the designation of the second tracking session as the active tracking session.

In many more embodiments, the tracking response is received at the network-side interface based on a hash operation on the first data sequence. The new tracking response is received at the host-side interface based on the hash operation on a second data sequence of the one or more second data sequences.

In further additional embodiments, a method comprises in a network device including a host-side interface and a network-side interface: transmitting, to a host device via the host-side interface, a first tracking request including a first data sequence, receiving, at the network-side interface, a tracking response for the transmitted first tracking request, and generating one or more second tracking requests based on receiving the tracking response at the network-side interface. Each of the one or more second tracking requests includes a second data sequence that is different from the first data sequence. The method further comprises transmitting the generated one or more second tracking requests to the host device via the host-side interface.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual diagram of a cloud computing architecture in accordance with various embodiments of the disclosure;

FIG. 2 is a conceptual diagram of a communication network in accordance with various embodiments of the disclosure;

FIG. 3 is a schematic block diagram of a communication network for tracking a host device in accordance with various embodiments of the disclosure;

FIG. 4 is a flowchart depicting a process for determining a status of a virtual network function in accordance with various embodiments of the disclosure;

FIG. 5 is a flowchart depicting a process for transmitting one or more second tracking requests in accordance with various embodiments of the disclosure;

FIG. 6 is a flowchart depicting another process for determining the status of the virtual network function in accordance with various embodiments of the disclosure;

FIG. 7 is a flowchart depicting a process for deactivating previous tracking sessions in accordance with various embodiments of the disclosure;

FIG. 8 is a flowchart depicting a process for setting a new response timeout parameter in accordance with various embodiments of the disclosure; and

FIG. 9 is a conceptual block diagram of a network device suitable for configuration with a tracking logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to accurately and efficiently track a host device in a communication network. Host devices in several Ethernet virtual private network (EVPN) deployments are hidden behind all-active multi-homing segments. These host devices connect to multiple network devices to provide redundancy, ensuring high availability and reliability. Typically, these host devices support various networking functions that serve as next hops for applications deployed on servers. These networking functions need to be effectively tracked for the smooth operation of communication services.

Existing technology applies several methods to track a host device and/or networking functions running on the host device. For example, these methods involve a connected network device initiating a request to the host device and then waiting for a response from the host device. In an all-active redundancy mode, the host device might end up transmitting the response to a different network device rather than the one that sent the request. This situation can create a problem as the original network device may not receive the response and consequently may infer that the host device or the concerned networking function is inactive or out of service. This may lead to inefficiencies and gaps in network monitoring and management, as the original network device is unable to update its status or take necessary actions based on host's response.

Therefore, the present disclosure provides a network device (e.g., a router, a spine switch, or the like) for tracking a multi-homed host device in a communication network. In many embodiments, the communication network may include a physical layer that supports at least two network devices and a logical layer that supports the host device. The host device may include, for example, servers, desktops, laptops, mobile devices, printers, Internet of Things (IoT) devices, storage devices, virtual machines, and networking hardware. The host device may host at least one virtual network function (VNF). The “VNF” may refer to network functions based on which various network tasks such as routing, firewalling, and load balancing are performed by the host device. Each network device of the at least two network devices may include a network-side interface and a host-side interface. The network-side interface may connect a corresponding network device with the physical layer of the communication network. The host-side interface may connect the corresponding network device with the logical layer of the communication network. The at least two network devices may be further equipped with a tracking logic (for example, stored in memory or implemented as a hardware component in the at least two network devices) to facilitate tracking of the multi-homed host device (interchangeably referred to as “the host device”).

In a variety of embodiments, a first network device of the at least two network devices may transmit a first tracking request to the host device. The first tracking request may include a first data sequence including a plurality of data parameters. For example, the first data sequence may include two or more of a source Internet Protocol (IP) address, a destination IP address, a source port number, a destination port number, a protocol identifier, or the like. The first data sequence may correspond to an n-tuple vector that uniquely identifies a flow of the first tracking request and that can be utilized as input parameter in a hash operation or function at the host device. Upon receiving the first tracking request at the host device, the VNF may process the first tracking request and extract the necessary information, such as the first data sequence and other relevant fields from the first tracking request. Using the extracted information, the VNF may generate a first tracking response. The first tracking response may also include the first data sequence with source and destination information being swapped along with other details such as a link status. The host device may then output the first tracking response to one of the first network device or a second network device of the at least two network devices by applying the hash function or operation to the first data sequence in the first tracking response.

If the first tracking response is received by the first network device, the first network device may determine a status of the VNF as an active state. However, if the first tracking response is received by the second network device, the first network device could incorrectly determine the status of the VNF as an inactive state, resulting in false alerts. To prevent these false alerts, in various embodiments, the first tracking request may include a non-anycast unique IP address of the first network device as source IP address. The non-anycast unique IP address may correspond to a secondary routable address provisioned per Bridge Virtual Interface (BVI) or per Integrated Routing and Bridging (IRB) interface of the first network device. With this non-anycast unique IP address as the source IP address, even if the first tracking response is received by the second network device, the first tracking response is re-routed to the first network device via the physical layer.

Some more embodiments are based on a realization that the re-routing of the first tracking response may be subject to routing delays and may lead to potential network congestion. To this end, it is an objective of numerous embodiments to eliminate the re-routing delay for faster VNF failure detection. Thus, based on receiving the first tracking response at the network-side interface, the first network device may generate one or more second tracking requests and transmit the generated one or more second tracking requests to the host device via the host-side interface. Each second tracking request of the one or more second tracking requests may include a second data sequence that is different from the first data sequence. In still more embodiments, the second data sequence may be obtained based on a modification of the first data sequence. The modification of the first data sequence to obtain the second data sequence may be based on sampling at least one data parameter from the plurality of data parameters. For example, a value of at least one the plurality of data parameters in the first data sequence can be modified to obtain a second data sequence. Further, the second data sequences in the one or more second tracking requests are also different from each other. By sending multiple second tracking requests with varying n-tuple vectors, the first network device attempts to force a response at the host-side interface from the host device.

In numerous embodiments, at least one second tracking response transmitted by the host device may be received at the host-side interface of the first network device. In such a scenario, the first network device may designate the second data sequence of corresponding second tracking request as an active data sequence for one or more subsequent tracking requests. Further, the first network device may discard all other data sequences for generating the subsequent tracking requests.

In several embodiments, the first tracking request and the one or more second tracking requests may correspond to bidirectional forwarding detection (BFD) requests. For example, the “BFD requests” may be used to detect faults in bidirectional path between two network devices. The first tracking request may be associated with a first tracking session (e.g., a first BFD session) and the one or more second tracking requests may be associated with a second tracking session. The second tracking session may be established by the first network device based on receiving the first tracking response at the network-side interface of the first network device. The first tracking session may be associated with the first data sequence, indicating that any tracking request transmitted during the first tracking session will be associated with the first data sequence. Similarly, the second tracking session may be associated with the one or more second data sequences. Once the second tracking response is received at the host-side interface of the first network device, the first network device may designate the second tracking session as an active tracking session and deactivate the first tracking session based on the designation of the second tracking session as the active tracking session.

In several additional embodiments, the first tracking request and the one or more second tracking requests may be associated with a response timeout parameter. The response timeout parameter may define the maximum time the first network device will wait for a response to transmitted tracking requests. For example, when the first network device transmits the first tracking request to the host device, the first network device may set a specific response timeout parameter, within which the first network device expects a tracking response. If the first network device fails to receive the tracking response within this period, the first network device may infer that the host device or a VNF at the host device is inactive. In still additional embodiments, when the second tracking response is received at the host-side interface of the first network device, the first network device may set a new response timeout parameter for the one or more subsequent tracking requests. The new timeout parameter may be smaller than the initial timeout parameter, thus indicating that the re-routing delay has been eliminated.

Advantageously, receiving a re-routed tracking response at the network-side interface triggers the transmission of the one or more second tracking requests including varying second data sequences. By transmitting the one or more second tracking requests with varying second data sequences, the first network device is able to identify one such n-tuple vector that can result in a tracking response being received at the host-side interface of the first network device. Subsequent use of this n-tuple vector may eliminate the need for the second network device (e.g., a co-member of a multi-homing set) to re-route tracking responses to the first network device. Further, the transmission of subsequent tracking requests with the new response timeout parameter that is smaller than the response timeout parameter associated with the first tracking request and/or the one or more second tracking requests may allow faster fault detection. Accordingly, the tracking of the status of the virtual network function may be performed in an optimal manner.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

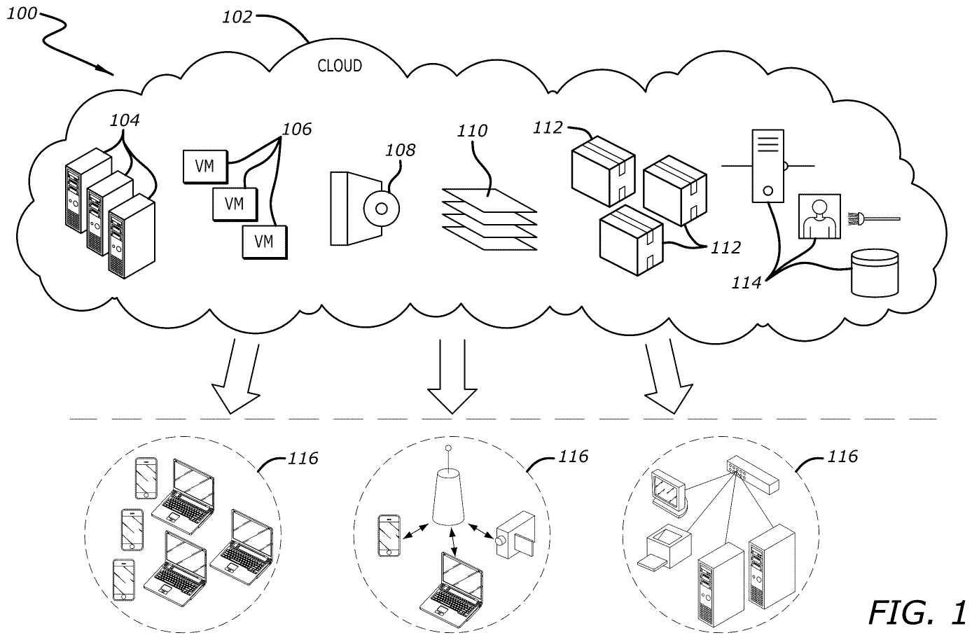

Referring to FIG. 1, a conceptual diagram of a cloud computing architecture 100 in accordance with various embodiments of the disclosure is shown. The cloud computing architecture 100 may include a cloud 102. The cloud 102 may correspond to one or more private clouds, one or more public clouds, and/or one or more hybrid clouds. In many embodiments, the cloud 102 may include cloud elements 104-114. In the embodiments shown in FIG. 1, the cloud elements 104-114 may include servers 104, virtual machines (VMs) 106, one or more software platforms 108, applications or services 110, software containers 112, and/or infrastructure nodes 114. As used herein, the infrastructure nodes 114 may correspond to one or more computing nodes, one or more storage nodes, one or more network nodes, and/or one or more management systems.

In a number of embodiments, the cloud 102 may provide various cloud computing services via the cloud elements 104-114. For example, the cloud computing services may include software as a service (SaaS), infrastructure as a service (IaaS), platform as a service (PaaS), and/or other types of services such as desktop as a service (DaaS), information technology management as a service (ITaaS), managed software as a service (MSaaS), mobile backend as a service (MBaaS), etc. The SaaS may include, for example, collaboration services, email services, enterprise resource planning services, content services, communication services, etc. The IaaS may include, for example, security services, networking services, systems management services, etc. The PaaS may include, for example, web services, streaming services, application development services, etc.

In a variety of embodiments, the cloud computing architecture 100 may further include client endpoints 116. The client endpoints 116 may connect with the cloud 102 to obtain one or more specific services from the cloud 102. The client endpoints 116 may communicate with the cloud elements 104-114 via one or more public networks (e.g., Internet), private networks, and/or hybrid networks (e.g., virtual private network). The client endpoints 116 may include any device with networking capabilities, such as a laptop computer, a tablet computer, a server, a desktop computer, a smartphone, a router, a switch, a smart television, a smart car, a sensor, a gaming system, a smart wearable object (e.g., smartwatch, etc.), a city or transportation system (e.g., traffic control, toll collection system, etc.), an internet of things (IoT) device, a camera, a network printer, a transportation system (e.g., airplane, train, motorcycle, boat, etc.), and/or the like.

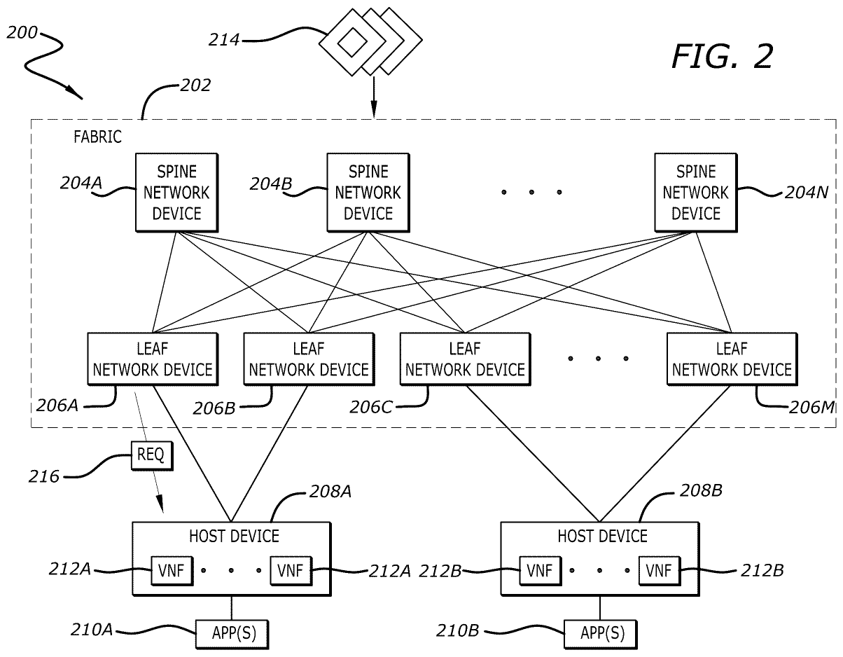

Although a specific embodiment of the cloud computing architecture 100 for carrying out the various steps, processes, methods, and operations described herein is discussed with respect to FIG. 1, any of a variety of systems and/or processes may be utilized in accordance with embodiments of the disclosure. For example, in several embodiments, the cloud computing architecture 100 may further include a fog layer, having fog nodes, between the cloud 102 and the client endpoints 116 for providing faster services and/or connectivity to the client endpoints 116. As used herein, the fog nodes may correspond to servers, switches, routers, controllers, and/or the like. The client endpoints 116 may communicate with the cloud 102 via the fog nodes. The elements depicted in FIG. 1 may also be interchangeable with other elements of FIGS. 2-9 as required to realize a particularly desired embodiment.

Referring to FIG. 2, a conceptual diagram of a communication network 200 in accordance with various embodiments of the disclosure is shown. The communication network 200 may correspond to a data center (or a service provider network) that supports and/or hosts a cloud (e.g., the cloud 102 illustrated in FIG. 1). The communication network 200 may include a fabric 202 which represents a physical layer or infrastructure (e.g., underlay) of the communication network 200. The fabric 202 may include spine network devices 204A-N and leaf network devices 206A-M. The spine network devices 204A-N may include N number of spine network devices, where N is an integer greater than 1. For example, the spine network devices 204A-N may correspond to routers, switches, and/or the like. The leaf network devices 206A-M may include M number of leaf network devices, where M is an integer greater than 1 and M may be (or may not be) equal to N. For example, the leaf network devices 206A-M may correspond to top-of-rack (“ToR”) switches, aggregation switches, gateways, ingress and/or egress switches, routers, provider edge devices, and/or any other type of routing or switching device.

In many embodiments, the leaf network devices 206A-M may be connected to the spine network devices 204A-N for routing or switching traffic within the fabric 202. In various embodiments, the leaf network devices 206A-M and the spine network devices 204A-N may be fully connected such that the connections between the leaf network devices 206A-M and the spine network devices 204A-N include redundant connections to avoid a failure in routing the traffic. For example, each leaf network device of the leaf network devices 206A-M may be connected to each spine network device of the spine network devices 204A-N.

Further, the leaf network devices 206A-M may connect the fabric 202 to an overlay or logical layer of the communication network 200. For example, the overlay or logical layer of the communication network 200 may include a first host device 208A, a second host device 208B, at least one first application 210A (referred to as “the first application 210A”), and at least one second application 210B (referred to as “the second application 210B”). Each of the first host device 208A and the second host device 208B may correspond to a virtual switch, a virtual router, and/or a tunnel endpoint that tunnels packets between the physical layer and the logical layer. The first application 210A and/or the second application 210B may include software applications, services, containers, appliances, functions, service chains, and/or the like. In several embodiments, the first application 210A or the second application 210B may be distributed, chained, or hosted by the first host device 208A or the second host device 208B, respectively. In several more embodiments, the first application 210A or the second application 210B may be executed by an endpoint different from the first host device 208A or the second host device 208B, respectively. The first application 210A may have a unique first virtual Internet Protocol (VIP) address and the second application 210B may have a unique second VIP address.

In a number of embodiments, each of the first host device 208A and the second host device 208B may be connected to at least two leaf network devices of the leaf network devices 206A-M. In other words, each of the first host device 208A and the second host device 208B may be multi-homed to a multi-homing set including the at least two leaf network devices as members of the multi-homing set. For example, the first host device 208A may be multi-homed to a first multi-homing set including leaf network devices 206A and 206B. Similarly, the second host device 208B may be multi-homed to a second multi-homing set including leaf network devices 206C-206M.

The first host device 208A may be multi-homed to the first multi-homing set via a first set of Ethernet links having a first Ethernet Segment (ES) identifier. The second host device 208B may be multi-homed to the second multi-homing set via a second set of Ethernet links having a second ES identifier. When a host device (e.g., the first host device 208A or the second host device 208B) is multi-homed, the host device may operate in one of an all-active redundancy mode or a single-active redundancy mode. In the all-active redundancy mode, all leaf network devices in a multi-homing set connected to the host device are allowed to forward traffic to/from the host device. In the single-active redundancy mode, a single leaf network device in a multi-homing set connected to the host device is allowed to forward traffic to/from the host device. The first host device 208A and/or the second host device 208B may be multi-homed to their corresponding multi-homing set to provide additional redundancy (such as the connection to the at least two leaf network devices) for tolerating network failures.

In operation, when the fabric 202 receives an access request (e.g., a data packet) designating the first application 210A or the second application 210B as a destination (referred to as “destination application”), the fabric 202 may route the access request to the first application 210A or the second application 210B via the first host device 208A or the second host device 208B, respectively. In a variety of embodiments, each of the first host device 208A and the second host device 208B may host (or support) a plurality of virtual network functions. For example, the first host device 208A may host a plurality of virtual network functions 212A and the second host device 208B may host a plurality of virtual network functions 212B. In numerous embodiments, the plurality of virtual network functions 212A and/or the plurality of virtual network functions 212B may be utilized as next hops (e.g., virtual next hops) to reach the first application 210A and/or the second application 210B, respectively. In numerous additional embodiments, the plurality of virtual network functions 212A and/or the plurality of virtual network functions 212B may correspond to virtual network forwarders (VNFs). As used herein, the VNFs may correspond to software-based network components that perform network functions such as routing, switching, and firewalling for applications (such as the first application 210A and/or the second application 210B) within the logical layer.

Since the plurality of virtual network functions (e.g., the plurality of virtual network functions 212A or 212B) is used as the next hops to reach the destination application (e.g., the first application 210A or the second application 210B), the plurality of virtual network functions should be in an active state to route the access request to the destination application. However, one or more virtual network functions of the plurality of virtual network functions may fail to operate due to their software failures or the like. In these cases, a controller 214 of the communication network 200 must be informed about statuses of the plurality of virtual network functions. Using the statuses of the plurality of virtual network functions, the controller 214 may select a different next hop to reach the destination application. For example, the controller 214 may correspond to one or more of a storage controller, a network controller, a powering controller, a security controller, an orchestration and automation controller, or an application delivery controller.

In order to track the status of a virtual network function in a host device (e.g., the first host device 208A or the second host device 208B), at least one leaf network device of corresponding multi-homing set (e.g., the first multi-homing set or the second first multi-homing set) may transmit, to the host device, a tracking request for the virtual network function. For example, as illustrated in FIG. 2, the leaf network device 206A may transmit, to the first host device 208A, a tracking request 216 (denoted as “REQ” in FIG. 2) to track a virtual network function of the plurality of virtual network functions 212A. Upon receiving the tracking request 216 at the first host device 208A, the virtual network function may generate a tracking response for the tracking request 216 and transmit the generated tracking response to a network interface card (NIC) of the first host device 208A. When the first host device 208A is in the all-active redundancy mode, the first host device 208A may opt, among the first set of Ethernet links, an Ethernet link for forwarding the tracking response. In a case where the opted Ethernet link corresponds to the Ethernet link associated with the leaf network device 206A, the leaf network device 206A may receive the response for the tracking request 216 and determine the status of the virtual network function as an active state. However, if the opted Ethernet link corresponds to the Ethernet link associated with the leaf network device 206B, the leaf network device 206A may not receive the response for the tracking request 216 and can incorrectly determine the status of the virtual network function as an inactive state.

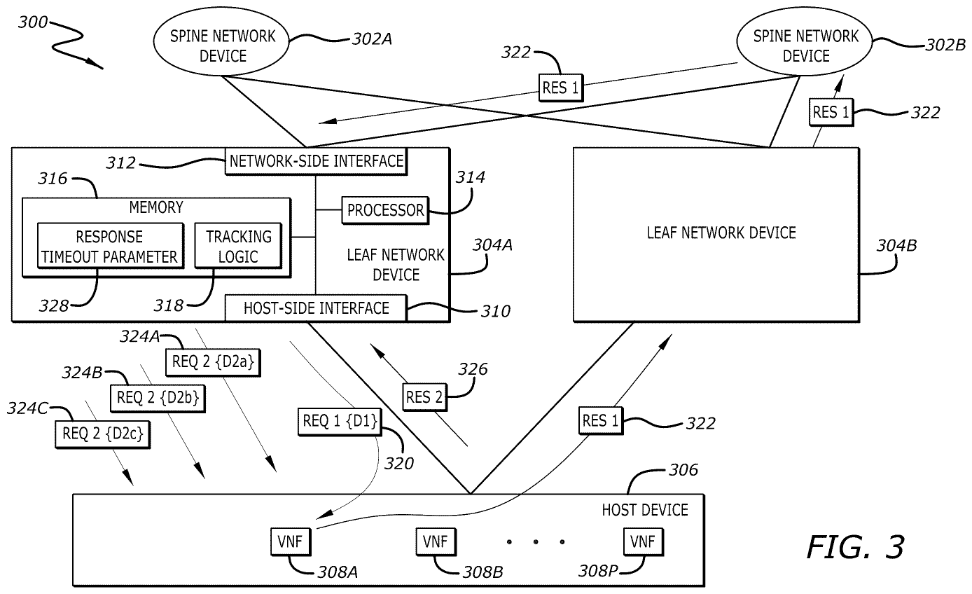

To this end, in more embodiments, the at least one leaf network device of the multi-homing set may comprise a tracking logic for accurately tracking the statuses of the plurality of virtual network functions even when the tracking response for a tracking request is transmitted to a co-member of the multi-homing set. In some more embodiments, the controller 214 may comprise the tracking logic for controlling the at least one leaf network device of the multi-homing set to accurately track the statuses of the plurality of virtual network functions. The tracking logic for accurately tracking the statuses of the plurality of virtual network functions is explained in detail in conjunction with FIG. 3-8.

Although a specific embodiment of the communication network 200 for carrying out the various steps, processes, methods, and operations described herein is discussed with respect to FIG. 2, any of a variety of systems and/or processes may be utilized in accordance with embodiments of the disclosure. For example, the communication network 200 may include any finite number of host devices and any finite number of applications. Further, for example, each of the first host device 208A and the second host device 208B may be associated with a single application. The elements depicted in FIG. 2 may also be interchangeable with other elements of FIGS. 1 and 3-9 as required to realize a particularly desired embodiment.

Referring to FIG. 3, a schematic block diagram of a communication network 300 for tracking a host device 306 in accordance with various embodiments of the disclosure is shown. In the embodiments illustrated in FIG. 3, the communication network 300 is shown to include a first spine network device 302A, a second spine network device 302B, a first leaf network device 304A, a second leaf network device 304B, and the host device 306. Each of the first spine network device 302A and the second spine network device 302B may be connected to each of the first leaf network device 304A and the second leaf network device 304B. In many embodiments, the first leaf network device 304A and the second leaf network device 304B may be connected to the host device 306. In other words, the host device 306 may be multi-homed to the first leaf network device 304A and the second leaf network device 304B. In other words, the first leaf network device 304A and the second leaf network device 304B may be members of a multi-homing set connected to the host device 306. Further, the host device 306 may host a plurality of virtual network functions 308A-P. The plurality of virtual network functions 308A-P may include P virtual network functions, where P is an integer that can be greater than or equal to 1. In numerous embodiments, the plurality of virtual network functions 308A-P may correspond to VNFs.

In a variety of embodiments, the first leaf network device 304A may include a plurality of network components 310-316, where each network component of the plurality of network components 310-316 may be communicatively coupled to each other via a communication bus. The plurality of network components 310-316 may include a host-side interface 310, a network-side interface 312, a processor 314, and a memory 316. It will be understood by a person of ordinary skill in the art that the first leaf network device 304A and the second leaf network device 304B may be functionally and/or structurally similar to each other.

The host-side interface 310 may be an interface to connect with a logical layer or overlay section of the communication network 300. As used herein, the logical layer (or the overlay section) may correspond to a virtual network built on top of a network infrastructure section, where the virtual network enables for various logical connections that are independent of physical connections for allowing more flexibility and scalability of the communication network 300. For example, the host-side interface 310 may be communicatively coupled to the host device 306 representing the logical layer via a single-hop connection. In other words, the host-side interface 310 can be directly coupled to the host device 306. The network-side interface 312 may be an interface to connect with a physical layer or underlay section of the communication network 300. As used herein, the physical layer (or the underlay section) may correspond to a physical network infrastructure layer that includes various hardware components (such as spine network devices and/or leaf network devices) and physical connections for ensuring reliable and efficient movement of data across the communication network 300. Thus, the network-side interface 312 may be communicatively coupled to the host device 306 via a multi-hop connection, e.g., via the physical layer. For example, the network-side interface 312 may be coupled to the host device 306 via intermediate nodes (such as the second spine network device 302B and the second leaf network device 304B or the first spine network device 302A and the second leaf network device 304B) in a network fabric.

Each of the host-side interface 310 and the network-side interface 312 may correspond to one or more of an Ethernet interface, a Wi-Fi interface, a fiber optic interface, or a cellular interface. The host-side interface 310 and the network-side interface 312 may be associated with a primary Internet Protocol (IP) address and a Media Access Control (MAC) address. In an example, the primary IP address may correspond to an anycast routable address assigned to multiple network interfaces (e.g., the first leaf network device 304A and the second leaf network device 304B). In other words, the first leaf network device 304A and the second leaf network device 304B may share the same primary IP address.

The processor 314 may include suitable logic, circuitry, and interfaces that are configured to execute instructions stored in the memory 316. The processor 314 may correspond to an application-specific integrated circuit (ASIC) processor, a complex instruction set computing (CISC) processor, a central processing unit (CPU), an explicitly parallel instruction computing (EPIC) processor, a very long instruction word (VLIW) processor, and/or other processors or circuits.

The memory 316 may comprise suitable logic, circuitry, and interfaces that are configured to store a machine code and/or the instructions executable by the processor 314. The memory 316 may correspond to random access memory (RAM), read only memory (ROM), electrically erasable programmable read-only memory (EEPROM), hard disk drive (HDD), a solid-state drive (SSD), a CPU cache, and/or a secure digital (SD) card.

In a number of embodiments, the memory 316 may embody or include a tracking logic 318. In various examples, the tracking logic 318 can be a set of instructions stored within the memory 316, which when executed by the processor 314 can carry out various tracking and monitoring operations. In several embodiments, the tracking logic 318 may be configured to track the host device 306. More specifically, the tracking logic 318 may be configured to track statuses of one or more virtual network functions of the plurality of virtual network functions 308A-P in the host device 306. In order to track the status of a virtual network function of the plurality of virtual network functions 308A-P, the tracking logic 318 may be configured to transmit, to the host device 306, a tracking request for the virtual network function. For example, the tracking logic 318 may be configured to transmit, to the host device 306 via the host-side interface 310, a first tracking request 320 (denoted as “REQ 1” in FIG. 3) to track the status of the virtual network function 308A.

In various embodiments, the first tracking request 320 may include a first data sequence (denoted as “D1” in FIG. 3). The first data sequence may include a plurality of fields or data parameters in a packet header or payload that can be utilized as input parameters to a hash operation or function running at the host device 306. In an example, the first data sequence may include two or more of a source IP address, a destination IP address, a source MAC address, a destination MAC address, a source port number, a destination port number, a communication protocol identifier, etc. In other words, the first data sequence may correspond to an n-tuple vector that uniquely identifies a flow of the first tracking request 320 and that can be utilized as input parameter in the hash operation or function at the host device 306. The first tracking request 320 may further include a secondary IP address associated with the first leaf network device 304A. In several embodiments, the secondary IP address may be a non-anycast IP address utilized to uniquely identify the first leaf network device 304A in the communication network 300 and may be different from the primary IP address associated with the first leaf network device 304A. In an example, the secondary IP address may correspond to a secondary routable address provisioned per Bridge Virtual Interface (BVI) or per Integrated Routing and Bridging (IRB) interface of the first leaf network device 304A.

Upon receiving the first tracking request 320 at the host device 306, the virtual network function 308A, if active, may process the first tracking request 320 and extract the necessary information, such as the first data sequence and other relevant fields from the first tracking request 320. Using the extracted information, the virtual network function 308A may generate a first tracking response 322 (denoted as “RES 1” in FIG. 3). The first tracking response 322 may include the first data sequence with source and destination information being swapped, the secondary IP address, and other details such as a link status. Further, the virtual network function 308A may forward the first tracking response 322 to an NIC of the host device 306. The NIC of the host device 306 may execute a hashing algorithm (or a hash operation) on the first tracking response 322 to hash the first tracking response 322 to one of a link associated with the first leaf network device 304A or a link associated with the second leaf network device 304B. The hashing algorithm may utilize two or more data parameters from the first data sequence as input parameters to hash the first tracking response 322. For example, the hashing algorithm may correspond to a hash-based equal-cost multi-path (ECMP) algorithm. Additionally, or alternatively, the hashing algorithm may correspond to a consistent hashing algorithm, a highest random weight (HRW) hashing algorithm, a modulo hashing algorithm, and/or the like.

In a case where the first tracking response 322 is hashed to the link associated with the first leaf network device 304A, the first leaf network device 304A may receive the first tracking response 322 for the first tracking request 320 at the host-side interface 310. Specifically, the tracking logic 318 may be configured to receive the first tracking response 322 at the host-side interface 310 and determine the status of the virtual network function 308A as an active state. In such a scenario, the tracking logic 318 may be configured to re-utilize the same first data sequence in subsequent tracking requests.

Conversely, if the first tracking response 322 is hashed to the link associated with the second leaf network device 304B, the second leaf network device 304B may receive the first tracking response 322. Upon receiving the first tracking response 322, the second leaf network device 304B may verify whether the secondary IP address in the first tracking response 322 belongs to the second leaf network device 304B or another leaf network device. In the current example scenario, the second leaf network device 304B may determine that the secondary IP address in the first tracking response 322 belongs to the first leaf network device 304A, which is a co-member of the multi-homing set. As a result, the second leaf network device 304B may forward, based on the secondary IP address included in the first tracking response 322, the first tracking response 322 to one of the first spine network device 302A or the second spine network device 302B. For example, the second leaf network device 304B may forward the first tracking response 322 to the second spine network device 302B. The second spine network device 302B may forward, based on the secondary IP address included in the first tracking response 322, the first tracking response 322 to the first leaf network device 304A. Thus, the first leaf network device 304A may receive the first tracking response 322 for the first tracking request 320 at the network-side interface 312. Specifically, the tracking logic 318 may be configured to receive the first tracking response 322 at the network-side interface 312 and determine the status of the virtual network function 308A as the active state. In other words, the first tracking response 322 may be received at the network-side interface 312 based on the hash operation (or hashing algorithm) on the first data sequence.

Since the first tracking response 322 is routed via the second leaf network device 304B and the second spine network device 302B, the first tracking response 322 may be subject to routing delays. To address this issue, in some more embodiments, the tracking logic 318 may be configured to generate a plurality of second tracking requests 324A-C (denoted as “REQ 2”) based on receiving the first tracking response 322 at the network-side interface 312. Each second tracking request of the plurality of second tracking requests 324A-C may include a second data sequence different from the first data sequence included in the first tracking request 320. Each second data sequence may be obtained based on a modification of the first data sequence. For example, the second data sequence may include at least one modified data parameter of the two or more data parameters, of the first data sequence, utilized in the hashing algorithm at the host device 306. In an example scenario, the tracking logic 318 may modify a value of the source MAC address utilized in the first data sequence to obtain a second data sequence. Likewise, the tracking logic 318 can modify the values of any of the data parameters included in the first data sequence to obtain different second data sequences for the plurality of second tracking requests 324A-C. Second data sequences included in the plurality of second tracking requests 324A-C are denoted as “D2a”, “D2b”, and “D2c” in FIG. 3. In other words, the second data sequences in the plurality of second tracking requests 324A-C are different from each other. By sending multiple second tracking requests 324A-C with varying n-tuple vectors (e.g., the second data sequences), the first leaf network device 304A attempts to force a response at the host-side interface 310 from the host device 306.

Further, the tracking logic 318 may be configured to transmit the plurality of second tracking requests 324A-C to the host device 306. In additional embodiments, the tracking logic 318 may be configured to simultaneously transmit the plurality of second tracking requests 324A-C to the host device 306. In further embodiments, the plurality of second tracking requests 324A-C may be sequentially transmitted to the host device 306. Upon receiving the plurality of second tracking requests 324A-C, the host device 306 may generate corresponding second tracking responses.

In a non-limiting example, at least one second tracking response may be hashed to the link associated with the host-side interface 310. For example, the host device 306 may hash a second tracking response 326 (denoted as “RES 2” in FIG. 3) to the link associated with the host-side interface 310. As a result, the tracking logic 318 may be configured to receive the second tracking response 326 and determine the status of the virtual network function 308A as the active state. In other words, the second tracking response 326 may be received at the host-side interface 310 based on the hash operation (or hashing algorithm) on the second data sequence.

In yet additional embodiments, a second data sequence that resulted in the second tracking response 326 to be hashed to the link associated with the host-side interface 310 may be utilized by the tracking logic 318 for transmitting any subsequent tracking request to the host device 306. In other words, the tracking logic 318 may designate the second data sequence as an active data sequence for one or more subsequent tracking requests. Further, other second data sequences and the first data sequence that resulted in tracking responses to be received at the network-side interface 312 may be discarded by the tracking logic 318.

Since the second tracking response 326 is not routed via spine network devices (such as the first spine network device 302A and/or the second spine network device 302B), a response time associated with the second tracking response 326 may be lesser than the response time associated with the first racking response 322. Accordingly, the tracking logic 318 can accurately and efficiently determine the status of the virtual network function 308A. In this way, the tracking logic 318 may be configured to track the statuses of the plurality of virtual network functions 308A-P by individually transmitting tracking request(s) (e.g., the first tracking request 320 and/or the plurality of second tracking requests 324A-C) for a corresponding network function of the plurality of virtual network functions 308A-P.

In several embodiments, the first tracking request 320 and the plurality of second tracking requests 324A-C may correspond to Bidirectional Forwarding Detection (BFD) requests. For example, a “BFD request” may be utilized to detect faults in bidirectional path between two network devices (e.g., the first leaf network device 304A and the virtual network function 308A at the host device 306). The first tracking request 320 may be associated with a first tracking session (e.g., a first BFD session) and the plurality of second tracking requests 324A-C may be associated with at least one second tracking session (e.g., a second BFD session). The second tracking session may be established by the tracking logic 318 based on receiving the first tracking response 322 at the network-side interface 312. The first tracking session may be associated with the first data sequence, indicating that any tracking request transmitted during the first tracking session will be associated with the first data sequence. Similarly, the second tracking session may be associated with the second data sequences. Once the second tracking response 326 is received at the host-side interface 310, the tracking logic 318 may designate the second tracking session as an active tracking and deactivate the first tracking session.

In numerous additional embodiments, the first tracking request 320 and the plurality of second tracking requests 324A-C may be associated with a response timeout parameter 328. In an example, the response timeout parameter 328 may be stored in the memory 316. The response timeout parameter 328 may be configured to define the maximum time the tracking logic 318 will wait for a tracking response to a tracking request. For example, when the tracking logic 318 transmits the first tracking request 320 to the host device 306, the tracking logic 318 may set a value for the response timeout parameter 328, within which the tracking logic 318 expects a response to the first tracking request 320 from the host device 306. If the tracking logic 318 fails to receive a response within the time period defined by the response timeout parameter 328, the tracking logic 318 may be configured to determine the status of the virtual network function 308A as an inactive state.

In further embodiments, if a response is received within the time duration defined by the response timeout parameter 328 but at the network-side interface 312, the tracking logic 318 may be configured to determine a new value for the response timeout parameter 328 based on a response that is received at the host-side interface 310. The new value of the response timeout parameter 328 may be lesser or smaller than the previous value. In an example, the new value for the response timeout parameter 328 may be determined as a round trip time it takes for the tracking logic 318 to receive the second tracking response 326 at the host-side interface 310. This round trip time may encompass the total time duration from when a corresponding second tracking request is transmitted to the host device 306, traverses the network to reach the host device 306, is processed by the virtual network function 308A, and then the second tracking response 326 is transmitted back to the first leaf network device 304A at the host-side interface 310. Upon setting the new value for the response timeout parameter 328, the tracking logic 318 may be configured to utilize the new response timeout parameter 328 for subsequent tracking requests.

In more embodiments, the tracking logic 318 may be configured to track the status of the virtual network function 308A in an optimal manner based on the first tracking request 320 and the plurality of second tracking requests 324A-C. In order to optimally track the status of the virtual network function 308A, the tracking logic 318 may be configured to transmit, to the host device 306, one or more new tracking requests with a data sequence (e.g., the second data sequence) that resulted in a tracking response to be hashed to the link associated with the host-side interface 310. For example, the one or more new tracking requests may be transmitted subsequent to the plurality of second tracking requests 324A-C (or the first tracking request 320). Further, the one or more new tracking requests may be associated with the new response timeout parameter 328. Since the one or more new tracking requests are associated with the new response timeout parameter 328 having the newly set value lesser than the previous value, the tracking logic 318 may be configured to track the status of the virtual network function 308A faster than the tracking of the status of the virtual network function 308A using prior tracking requests (e.g., the first tracking request 320 or the plurality of second tracking requests 324A-C).

Although a specific embodiment of the communication network 300 for carrying out the various steps, processes, methods, and operations described herein is discussed with respect to FIG. 3, any of a variety of systems and/or processes may be utilized in accordance with embodiments of the disclosure. For example, the tracking logic 318 may be embodied or included in the processor 314 or as a standalone component, for example, a dedicated controller, in the first leaf network device 304A. In such an embodiment, the processor 314 or the dedicated controller may be configured to generate the plurality of second tracking requests 324A-C (denoted as “REQ 2”) based on receiving the first tracking response 322 at the network-side interface 312. Each second tracking request of the plurality of second tracking requests 324A-C may include a second data sequence different from the first data sequence included in the first tracking request 320. The processor 314 or the dedicated controller may be configured to obtain each second data sequence based on a modification of the first data sequence. For example, the second data sequence may include at least one modified data parameter of the two or more data parameters, of the first data sequence, utilized in the hashing algorithm at the host device 306. In an example scenario, the processor 314 or the dedicated controller may modify a value of the source MAC address utilized in the first data sequence to obtain a second data sequence. Likewise, the processor 314 or the dedicated controller can modify the values of any of the data parameters included in the first data sequence to obtain different second data sequences for the plurality of second tracking requests 324A-C. In other words, the processor 314 or the dedicated controller may be configured to facilitate sending of multiple second tracking requests 324A-C with varying n-tuple vectors (e.g., the second data sequences) to the host device 306 to force a response at the host-side interface 310 from the host device 306. Further, the processor 314 or the dedicated controller may be configured to perform various other operations as described in the foregoing description with respect to the tracking logic 318. The elements depicted in FIG. 3 may also be interchangeable with other elements of FIGS. 1-2 and 4-9 as required to realize a particularly desired embodiment.

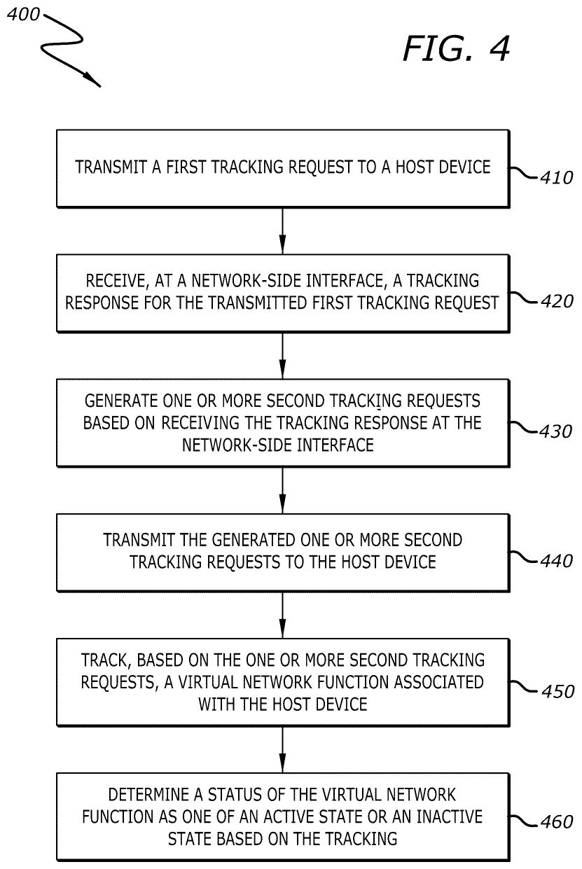

Referring to FIG. 4, a flowchart depicting a process 400 for determining a status of a virtual network function in accordance with various embodiments of the disclosure is shown. In many embodiments, the process 400 may transmit a first tracking request to a host device (block 410). In an example, the first tracking request may be transmitted from a leaf network device of a communication network to the host device of the communication network via a host-side interface of the leaf network device. The leaf network device may be a member of a multi-homing set coupled to the host device. The multi-homing set may include one or more additional leaf network devices connected to the host device. In various embodiments, the first tracking request may include a first data sequence having a plurality of data parameters. The plurality of data parameters may form an n-tuple vector which can be utilized as an input to a hashing algorithm executed at the host device. For example, the plurality of data parameters may include two or more of a source IP address, a destination IP address, a source MAC address, a destination MAC address, a source port number, a destination port number, a communication protocol identifier, etc. In some more embodiments, the first tracking request may correspond to a bidirectional forwarding detection (BFD) request for tracking the status of the virtual network function associated with the host device. In additional embodiments, the host device may host (or support) the virtual network function. Upon receiving the first tracking request at the host device, the virtual network function may generate a tracking response and transmit the tracking response for the first tracking request to an NIC of the host device. The NIC of the host device may execute the hashing algorithm on the tracking response to hash the tracking response to one of a link associated with the leaf network device or a link associated with any of the one or more additional leaf network devices of the multi-homing set. When the tracking response is hashed to the link associated with the leaf network device, the tracking response may be received at the host-side interface of the leaf network device. Conversely, when the tracking response is hashed to the link associated with the one or more additional leaf network devices, the tracking response may be received at a network-side interface of the leaf network device. For example, the tracking response may be routed to the leaf network device via the one or more additional leaf network devices and/or spine network devices of the communication network.

In a number of embodiments, the process 400 may receive, at the network-side interface, the tracking response for the transmitted first tracking request (block 420). For example, the tracking response may be received at the network-side interface of the leaf network device. Receiving the tracking response at the network-side interface may indicate that the tracking response has been routed through the communication network, possibly involving a co-member of the multi-homing set and/or one or more spine network devices of the communication network.

In a variety of embodiments, the process 400 may generate one or more second tracking requests based on receiving the tracking response at the network-side interface (block 430). Since the tracking response is received at the network-side interface, the received tracking response may be subjected to routing delays. In order to avoid (or remove) the routing delays, the tracking response should be hashed to the link associated with the leaf network device at the host device. In other words, the tracking response should be received at the host-side interface. Accordingly, the process 400 may generate the one or more second tracking requests by modifying the input parameters of the hashing algorithm in anticipation that a new tracking response for the one or more second tracking requests will be received at the host-side interface. In more embodiments, each of the one or more second tracking requests may include a second data sequence having at least one modified input parameter of the input parameters. In still more embodiments, the second data sequence may be different from the first data sequence. For example, the second data sequence may include the plurality of data parameters with at least one data parameter having a different value from the first data sequence. In still more embodiments, the one or more second tracking requests may correspond to BFD requests for tracking the status of the virtual network function associated with the host device.

In numerous embodiments, the process 400 may transmit the generated one or more second tracking requests to the host device (block 440). For example, the generated one or more second tracking requests may be transmitted from the leaf network device to the host device via the host-side interface of the leaf network device. In further embodiments, the generated one or more second tracking requests may be sequentially transmitted from the leaf network device to the host device. In still further embodiments, the generated one or more second tracking requests may be simultaneously transmitted from the leaf network device to the host device.

In several embodiments, the process 400 may track, based on the one or more second tracking requests, the virtual network function associated with the host device (block 450). In several more embodiments, each of the one or more second tracking requests may be associated with a response timeout parameter. For example, the response timeout parameter may indicate a maximum amount of time that the process 400 would wait to receive one or more tracking responses for the transmitted one or more second tracking requests. In order to track the virtual network function, the process 400 may wait to receive the one or more tracking responses for the transmitted one or more second tracking requests within the time duration specified by the response timeout parameter.

In still additional embodiments, the process 400 may determine the status of the virtual network function as one of an active state or an inactive state based on the tracking (block 460). For example, the process 400 may determine the status of the virtual network function as the active state if a new tracking response for the one or more second tracking requests is received within the response timeout parameter. Conversely, the process 400 may determine the status of the virtual network function as the inactive state if the new tracking response is not received or received upon expiration of the response timeout parameter. In numerous additional embodiments, when the generated one or more second tracking requests are sequentially transmitted from the leaf network device to the host device, the process 400 may separately determine the status of the virtual network function for each transmitted second tracking request of the one or more second tracking requests. In yet more embodiments, when the generated one or more second tracking requests are simultaneously transmitted from the leaf network device to the host device, the process 400 may determine the status of the virtual network function as the active state if a new tracking response is received for one of the one or more second tracking requests.

Although a specific embodiment for the process 400 for carrying out the various steps, processes, methods, and operations described herein is discussed with respect to FIG. 4, any of a variety of systems and/or processes may be utilized in accordance with embodiments of the disclosure. For example, the process 400 may further determine the status of the virtual network function as the active state based on receiving the tracking response for the first tracking request at the network-side interface. The elements depicted in FIG. 4 may also be interchangeable with other elements of FIGS. 1-3 and 5-9 as required to realize a particularly desired embodiment.

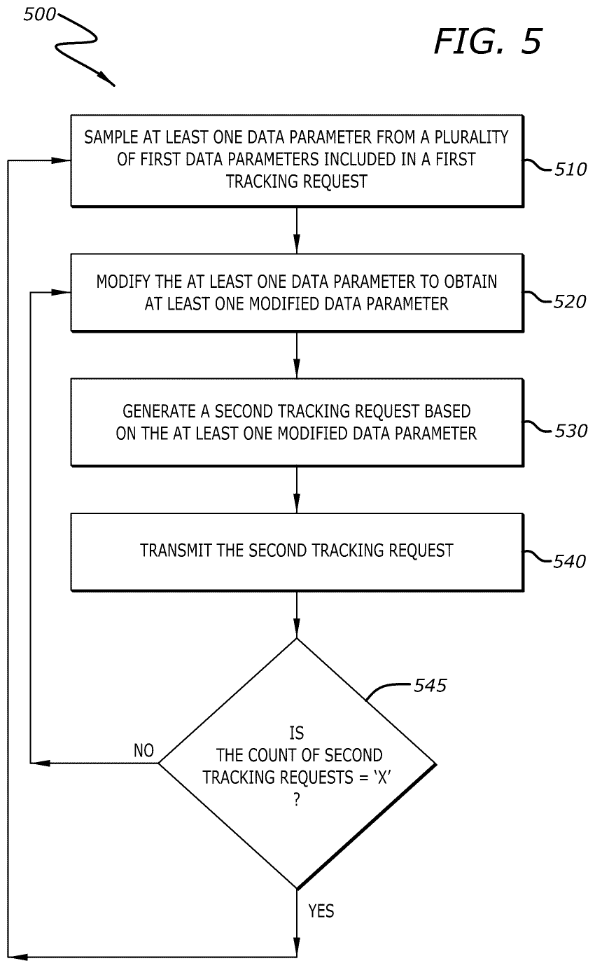

Referring to FIG. 5, a flowchart depicting a process 500 for transmitting one or more second tracking requests in accordance with various embodiments of the disclosure is shown. In many embodiments, the process 500 may sample at least one data parameter from a plurality of first data parameters included in a first tracking request (block 510). In various embodiments, the process 500 may execute a sampling algorithm on the plurality of first data parameters to sample the at least one data parameter. For example, the sampling algorithm may correspond to a random sampling algorithm, a systematic sampling algorithm, a stratified sampling algorithm, a reservoir sampling algorithm, and/or the like. In some more embodiments, the sampling of the at least one data parameter may be performed, for generating one or more second tracking requests, in response to receiving a tracking response for the first tracking request at a network-side interface of a leaf network device.

In a number of embodiments, the process 500 may modify the at least one data parameter to obtain at least one modified data parameter (block 520). In additional embodiments, the process 500 may execute a modifying algorithm on the at least one data parameter to obtain the at least one modified data parameter. For example, the modifying algorithm may correspond to a hit-and-trial modification algorithm that changes values of the at least one data parameter. In an example, if the at least one data parameter having a first value is inputted to the modifying algorithm, the modifying algorithm may output the modified data parameter having a second value.

In a variety of embodiments, the process 500 may generate a second tracking request based on the at least one modified data parameter (block 530). In more embodiments, the generated second tracking request may include a plurality of second data parameters. In order to generate the second tracking request having the plurality of second data parameters, the process 500 may replace, in the plurality of first data parameters, the sampled at least one data parameter with the at least one modified data parameter. In more further embodiments, the generation of the second tracking request may be associated with a count indicating the number of second tracking requests generated by the process 500. In an example, upon the generation of the second tracking request, the process 500 may increment the count of second tracking requests by 1.

In several embodiments, the process 500 may transmit the second tracking request (block 540). For example, the second tracking request may be transmitted from the leaf network device of a communication network to a host device of the communication network. In several more embodiments, the second tracking request may correspond to a BFD request for tracking a virtual network hosted on the host device.

In numerous embodiments, the process 500 may determine if the count of second tracking requests is equal to a preset number X (block 545). For example, the present number X is an integer that is greater than 1 (e.g., the present number X=4). The present number X may be determined based on a set of heuristics (rules) or one or more machine-learning processes. In still additional embodiments, the process 500 may compare the count of second tracking requests with the preset number X to obtain a comparison result indicating one of the count is equal to X or the count is not equal to X.

In numerous additional embodiments, if the count of second tracking requests is not equal to the preset number X, the process 500 may modify the at least one data parameter to obtain at least one new modified data parameter (block 520). In an example, the at least one new modified data parameter may be different from the at least one modified data parameter. However, in further additional embodiments, when the count of second tracking requests is equal to the preset number X, the process 500 may sample at least one new data parameter from the plurality of first data parameters (block 510). For example, the newly sampled at least one data parameter may be different from the previously sampled at least one data parameter.

Although a specific embodiment for the process 500 for carrying out the various steps, processes, methods, and operations described herein is discussed with respect to FIG. 5, any of a variety of systems and/or processes may be utilized in accordance with embodiments of the disclosure. For example, the process 500 may sample multiple data parameters from the plurality of first data parameters at the same time based on receiving the tracking response for the first tracking request at the network-side interface of the leaf network device. The elements depicted in FIG. 5 may also be interchangeable with other elements of FIGS. 1-4 and 6-9 as required to realize a particularly desired embodiment.

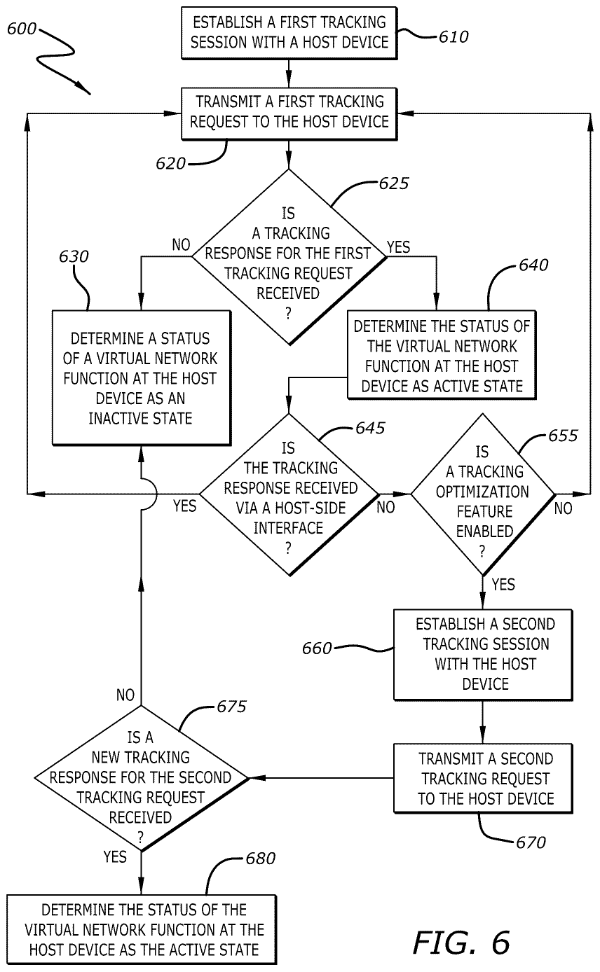

Referring to FIG. 6, a flowchart depicting a process 600 for determining a status of a virtual network function in accordance with various embodiments of the disclosure is shown. In many embodiments, the process 600 may establish a first tracking session with a host device (block 610). For example, the process 600 may establish the first tracking session between a leaf network device of a communication network and the host device of the communication network. In some embodiments, the first tracking session may be established to track the virtual network function associated with the host device. In some more embodiments, in the first tracking session, the process 600 may transmit one or more session parameters associated with the first tracking session to the host device. For example, the one or more session parameters may include a tracking request transmission frequency parameter, a response timeout parameter, and/or the like. For example, the tracking request transmission frequency parameter may indicate a frequency of transmission of a tracking request from the leaf network device to the host device in a specified time interval. The response timeout parameter may indicate a maximum amount of time that the process 600 would wait to receive a response for a transmitted tracking request. In yet some more embodiments, the first tracking session may correspond to a first bidirectional forwarding detection (BFD) session.

In a number of embodiments, the process 600 may transmit a first tracking request to the host device (block 620). For example, the process 600 may transmit, in the established first tracking session, the first tracking request from the leaf network device to the host device. The first tracking request may include a first data sequence that represents input parameters of a hashing algorithm of the host device. For example, the first data sequence may include a source IP address, a destination IP address, a source MAC address, a destination MAC address, a source port number, a destination port number, a communication protocol identifier, etc. The first tracking request may correspond to a BFD request for tracking the status of the virtual network function. Further, the first tracking session may be associated with the first data sequence.

In a variety of embodiments, the process 600 may determine if a tracking response for the first tracking request is received (block 625). For example, the process 600 may determine if one of a host-side interface of the leaf network device or a network-side interface of the leaf network device has received the tracking response for the first tracking request. In an example, the process 600 may check logs associated with the host-side interface and/or the network-side interface to determine if one of the host-side interface or the network-side interface has received the tracking response. In further embodiments, if the tracking response for the first tracking request is not received, the process 600 may determine the status of the virtual network function at the host device as an inactive state (block 630). For example, the inactive state may correspond to a dormant state, an idle state, a passive state, a link failure state, or the like.

However, in yet more embodiments, if the tracking response for the first tracking request is received, the process 600 may determine the status of the virtual network function at the host device as an active state (block 640). For example, the process 600 may determine that the virtual network function hosted by the host device is operational. The virtual network function hosted by the host device may correspond to a Virtual Network Forwarder (VNF).

In more embodiments, the process 600 may determine if the tracking response is received via the host-side interface (block 645). For example, the process 600 may utilize one or more interface inspecting tools, such as link layer discovery protocol tools, etc to determine if the tracking response is received via the host-side interface. In further more embodiments, if the tracking response is received via the host-side interface, the process 600 may continue to transmit the first tracking request to the host device (block 620).

However, in numerous embodiments, if the tracking response is not received via the host-side interface, the process 600 may determine if a tracking optimization feature is enabled (block 655). For example, the tracking optimization feature may have two states (e.g., an on-state and off-state). In numerous additional embodiments, the tracking optimization feature may be switched between the on-state and the off-state based on a user selection. On-state of the tracking optimization feature may indicate that the tracking of the status of the virtual network function should be done optimally and/or efficiently. If the tracking optimization feature is in the on-state, the process 600 may determine that the tracking optimization feature is enabled. Conversely, if the tracking optimization feature is in the off-state, the process 600 may determine that the tracking optimization feature is not enabled. In still more embodiments, if the tracking optimization feature is not enabled, the process 600 may continue to transmit the first tracking request to the host device (block 620).

However, in various embodiments, if the tracking optimization feature is enabled, the process 600 may establish a second tracking session with the host device (block 660). For example, the process 600 may establish the second tracking session between the leaf network device and the host device to track the virtual network function associated with the host device. The second tracking session may correspond to a second BFD session.

In several embodiments, the process 600 may transmit a second tracking request to the host device (block 670). For example, the process 600 may transmit, in the established second tracking session, the second tracking request from the leaf network device to the host device. The second tracking request may include a second data sequence that is different from the first data sequence. For example, the second tracking request may include at least one modified input parameter of the input parameters of the hashing algorithm. Further, the second tracking session may be associated with the second data sequence that is different from the first data sequence.

In additional embodiments, the process 600 may determine if a new tracking response for the second tracking request is received (block 675). For example, the process 600 may determine if one of the host-side interface of the leaf network device or the network-side interface of the leaf network device has received the new tracking response for the second tracking request. In still additional embodiments, if the new tracking response for the second tracking request is not received, the process 600 may determine the status of the virtual network function at the host device as the inactive state (block 630).

However, in still yet more embodiments, if the new tracking response for the second tracking request is received, the process 600 may determine the status of the virtual network function at the host device as the active state (block 680). For example, the active state of the virtual network function may indicate that the virtual network function is operational in the host device. The active state may correspond to an on-state, an enabled state, an engaged state, a busy state, or the like.

Although a specific embodiment for the process 600 for carrying out the various steps, processes, methods, and operations described herein is discussed with respect to FIG. 6, any of a variety of systems and/or processes may be utilized in accordance with embodiments of the disclosure. For example, the process 600 may transmit, to the host device, multiple second tracking requests in the second tracking session, each of the multiple second tracking requests may include the second data sequence that is different from the first data sequence in anticipation of forcing a response at the host-side interface from the host device. The elements depicted in FIG. 6 may also be interchangeable with other elements of FIGS. 1-5 and 7-9 as required to realize a particularly desired embodiment.

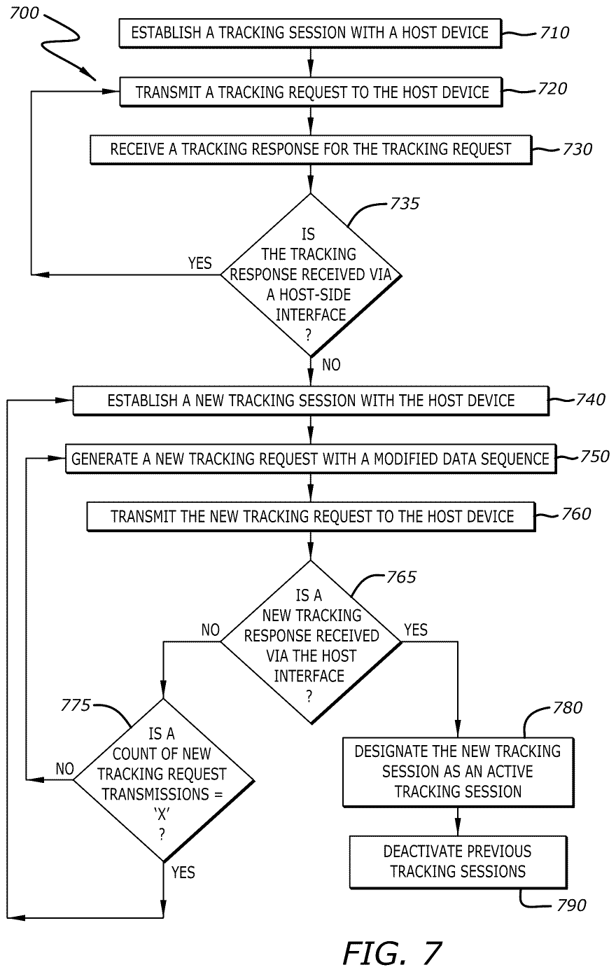

Referring to FIG. 7, a flowchart depicting a process 700 for deactivating previous tracking sessions in accordance with various embodiments of the disclosure is shown. In many embodiments, the process 700 may establish a tracking session with a host device (block 710). For example, the process 700 may establish the tracking session between a leaf network device of a communication network and the host device of the communication network. The tracking session may be a bidirectional forwarding detection (BFD) session for tracking a status of a virtual network function hosted on the host device.

In a number of embodiments, the process 700 may transmit a tracking request to the host device (block 720). For example, the process 700 may transmit, in the tracking session, the tracking request from the leaf network device to the host device. The tracking request may include a first data sequence having a plurality of first data parameters. The tracking session may be associated with the first data sequence, indicating all tracking requests in the tracking session may include the same plurality of first data parameters.

In a variety of embodiments, the process 700 may receive a tracking response for the tracking request (block 730). For example, the tracking response may be received via one of a network-side interface of the leaf network device or a host-side interface of the leaf network device. In response to receiving the tracking request at the host device, the virtual network function may generate the tracking response. Further, the host device may execute a hashing algorithm on the tracking response to hash the tracking response to one of a link associated with the network-side interface or a link associated with the host-side interface. The hashing algorithm may correspond to a hash-based ECMP algorithm, a consistent hashing algorithm, an HRW hashing algorithm, a modulo hashing algorithm, and/or the like.

In more embodiments, the process 700 may determine if the tracking response is received via the host-side interface (block 735). For example, one or more interface inspecting tools may be utilized to determine if the tracking response is received via the host-side interface. The one or more interface inspecting tools may correspond to link layer discovery protocol tools, and/or the like. The tracking response not being received via the host-side interface may indicate that the tracking response is received via the network-side interface. Further, the leaf network device may receive the tracking response via the network-side interface based on the first data sequence associated with the tracking session. In further additional embodiments, if the tracking response is received via the host-side interface, the process 700 may continue to transmit the tracking request to the host device (block 720).

However, in numerous embodiments, if the tracking response is not received via the host-side interface, the process 700 may establish a new tracking session with the host device (block 740). For example, the new tracking session may be established between the leaf network device and the host device. The new tracking session may correspond to a new BFD session for tracking the virtual network function hosted on the host device.

In numerous additional embodiments, the process 700 may generate a new tracking request with a modified data sequence (block 750). In few embodiments, the process 700 may modify the data sequence of the tracking request to generate the new tracking request with the modified data sequence. For example, the modified data sequence may include a plurality of second data parameters, where at least one data parameter of the plurality of second data parameters is different from at least one data parameter of the plurality of first data parameters. The new tracking session may be associated with the modified data sequence (e.g., a second data sequence).

In several embodiments, the process 700 may transmit the new tracking request to the host device (block 760). For example, the new tracking request may be transmitted from the leaf network device to the host device via the host-side interface of the leaf network device. In further embodiments, upon the transmission of the new tracking request, the process 700 may increment a count of new tracking request transmissions by 1. Upon receiving the new tracking request at the host device, the virtual network function may generate a new tracking response for the new tracking request. Further, the host device may execute the hashing algorithm on the new tracking request to hash the new tracking response to one of the link associated with the network-side interface or the link associated with the host-side interface.

In several more embodiments, the process 700 may determine if the new tracking response is received via the host-side interface (block 765). For example, the leaf network device may receive the new tracking response via one of the host-side interface or the network-side interface. In yet more embodiments, if the new tracking response is not received via the host-side interface, the process 700 may determine if the count of new tracking request transmissions is equal to a preset number X (block 775). For example, the present number X can be an integer that is greater than 1 (e.g., the present number X=4).

In additional embodiments, if the count of new tracking request transmissions is equal to the preset number X, the process 700 may establish another new tracking session with the host device (block 740). In the other new tracking session, a different parameter is modified to transmit new tracking requests in anticipation of forcing a response at the host-side interface from the host device.

However, in still yet more embodiments, if the count of new tracking request transmissions is not equal to the preset number X, the process 700 may generate a new tracking request with another modified data sequence (block 750). However, in some embodiments, if the new tracking response is received via the host-side interface, the process 700 may designate the new tracking session as an active tracking session (block 780). For example, the process 700 may mark the new tracking session as the active tracking session for tracking the status of the virtual network function and record one or more session parameters associated with the new tracking session. Additionally, or alternatively, the process 700 may designate the modified data sequence included in the new tracking request as an active data sequence for one or more subsequent tracking requests in the new tracking session.

In some more embodiments, the process 700 may deactivate previous tracking sessions (block 790). The previous tracking sessions may correspond to tracking sessions that were established prior to the new tracking session and resulted in tracking responses being received at the network-side interface of the leaf network device. For example, the process 700 may deactivate the tracking session that was established prior to the new tracking session.

Although a specific embodiment for the process 700 for carrying out the various steps, processes, methods, and operations described herein is discussed with respect to FIG. 7, any of a variety of systems and/or processes may be utilized in accordance with embodiments of the disclosure. For example, the process 700 may further modify the one or more session parameters associated with the new tracking session in response to designating the new tracking session as the active tracking session. The elements depicted in FIG. 7 may also be interchangeable with other elements of FIGS. 1-6 and 8-9 as required to realize a particularly desired embodiment.

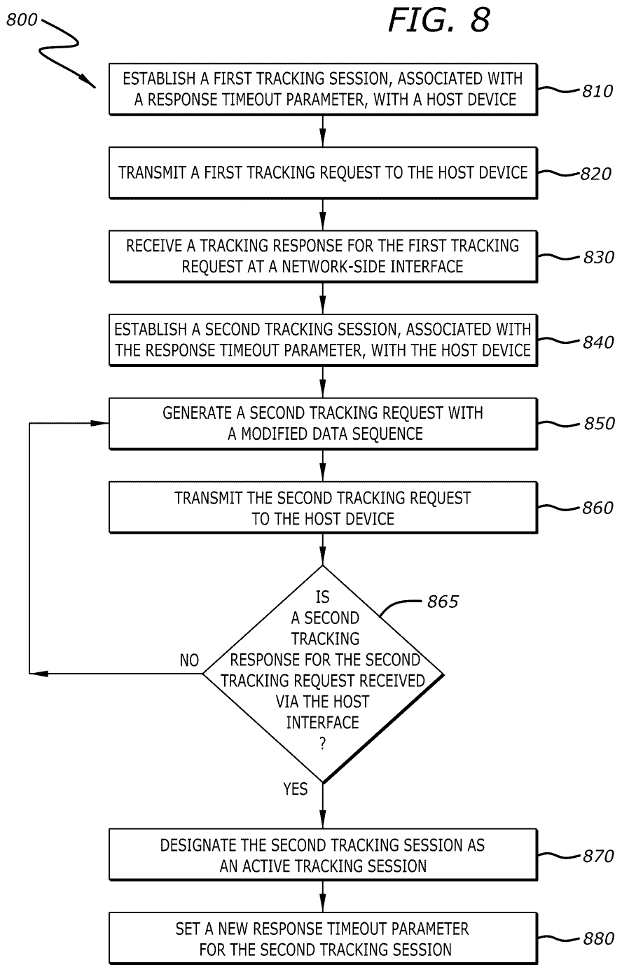

Referring to FIG. 8, a flowchart depicting a process 800 for setting a new response timeout parameter in accordance with various embodiments of the disclosure is shown. In many embodiments, the process 800 may establish a first tracking session, associated with a response timeout parameter, with a host device (block 810). For example, the process 800 may establish the first tracking session between a leaf network device of a communication network and the host device of the communication network. In various embodiments, the response timeout parameter may indicate the maximum amount of time that the process 800 would wait to receive a response for a transmitted tracking request. In some more embodiments, the first tracking session may be a first bidirectional forwarding detection (BFD) session for tracking a virtual network function hosted on the host device.

In a number of embodiments, the process 800 may transmit a first tracking request to the host device (block 820). For example, the process 800 may transmit, in the first tracking session, the first tracking request to the host device via a host-side interface of the leaf network device. The first tracking request may include a first data sequence that represents input parameters of a hashing algorithm of the host device.

In a variety of embodiments, the process 800 may receive a tracking response for the first tracking request at the network-side interface (block 830). For example, the host device may output, based on receiving the first tracking request, the tracking response to one of a link associated with the network-side interface or a link associated with the host-side interface. When the tracking response is outputted (or hashed) to the link associated with the host-side interface, the process 800 may receive the tracking response at the network-side interface in the first tracking session.

In more embodiments, the process 800 may establish a second tracking session, associated with the same response timeout parameter, with the host device (block 840). For example, the process 800 may establish the second tracking session between the leaf network device and the host device. In yet more embodiments, the second tracking session may be a second BFD session for tracking the virtual network function.

In numerous additional embodiments, the process 800 may generate a second tracking request with a modified data sequence (block 850). In few embodiments, the process 800 may execute a modifying algorithm (such as a hit and trail modification algorithm) on the first data sequence included in the first tracking request to obtain the modified data sequence. The modified data sequence may include at least one data parameter that is different value from the at least one data parameter included in the first data sequence.

In numerous additional embodiments, the process 800 may transmit the second tracking request to the host device (block 860). For example, the process 800 may transmit, in the second tracking session, the second tracking request to the host device via the host-side interface of the leaf network device. The host device may output, based on receiving the second tracking request, a second tracking response to one of the link associated with the network-side interface or the link associated with the host-side interface.

In several embodiments, the process 800 may determine whether the second tracking response for the second tracking request is received via the host-side interface (block 865). In still more embodiments, the process 800 check one or more logs associated with the host-side interface to determine if the received second tracking response is recorded in the one or more logs. In additional embodiments, if the second tracking response is not received via the host-side interface, the process 800 may generate another second tracking request with another modified data sequence (block 850).

However, in many additional embodiments, if the second tracking response is received via the host-side interface, the process 800 may designate the second tracking session as an active tracking session (block 870). For example, the process 800 may mark the second tracking session as the active tracking session for tracking the status of the virtual network function. Additionally, or alternatively, the process 800 may designate the modified data sequence included in the second tracking request as an active data sequence for one or more subsequent tracking requests in the second tracking session.

In still yet additional embodiments, the process 800 may set a new response timeout parameter for the second tracking session (block 880). In further additional embodiments, the new response timeout parameter may be set based on the response timeout parameter associated with the first tracking session and/or the second tracking session. For example, the process 800 may reduce the response timeout parameter associated with the second tracking session by a specific value to set the new response timeout parameter. The specific value may be determined through a set of heuristics (rules) or by one or more machine-learning processes. For example, the new value for the new response timeout parameter may be set as a round trip time including the total time duration from when the second tracking request is transmitted to the host device, traverses the network to reach the host device, is processed by the virtual network function, and then the second tracking response is transmitted back to the leaf network device at the host-side interface. Further, the new response timeout parameter may be set for the one or more subsequent tracking requests. The new response timeout parameter may be smaller than the response timeout parameter by the specific value.

Although a specific embodiment for the process 800 for carrying out the various steps, processes, methods, and operations described herein is discussed with respect to FIG. 8, any of a variety of systems and/or processes may be utilized in accordance with embodiments of the disclosure. For example, the process 800 may further deactivate the first tracking session in response to designating the second tracking session as the active tracking session. The elements depicted in FIG. 8 may also be interchangeable with other elements of FIGS. 1-7 and 9 as required to realize a particularly desired embodiment.

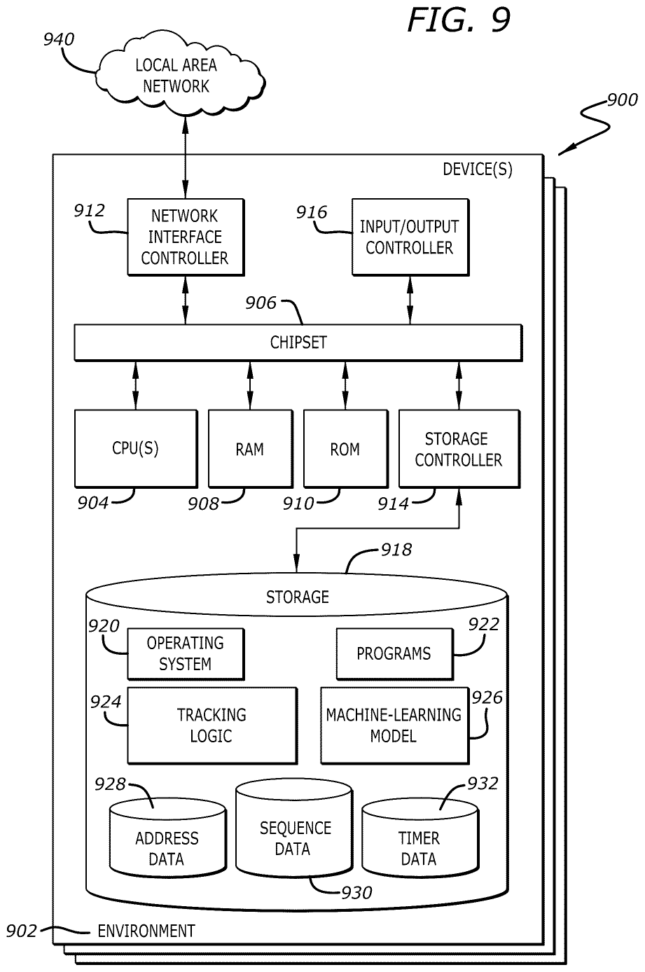

Referring to FIG. 9, a conceptual block diagram of a network device 900 suitable for configuration with a tracking logic, in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The network device 900 may, in many non-limiting examples, correspond to physical devices or to virtual resources described herein.

In many embodiments, the network device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the network device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the network device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the network device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the network device 900 and/or transferring information between the various components and devices. The ROM 910 or NVRAM can also store other application components necessary for the operation of the network device 900 in accordance with various embodiments described herein.

Additional embodiments of the network device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the network device 900 to other devices over the network 940. It is contemplated that multiple NICs 912 may be present in the network device 900, connecting the device to other types of networks and remote systems.

In further embodiments, the network device 900 can be connected to a storage 918 that provides non-volatile storage for data accessible by the network device 900. The storage 918 can, for instance, store an operating system 920, applications 922, address data 928, sequence data 930, and timer data 932 which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The network device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In still more embodiments, the network device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The network device 900 can further read or access information from the storage 918 by detecting the physical states or characteristics of one or more particular locations within the physical storage units.

In addition to the storage 918 described above, the network device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the network device 900. In some examples, the operations performed by a cloud computing network, and or any components included therein, may be supported by one or more devices similar to network device 900. Stated otherwise, some or all of the operations performed by the cloud computing network, and or any components included therein, may be performed by one or more network devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the network device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the network device 900.

In many additional embodiments, the storage 918 or other computer-readable storage media is encoded with computer-executable instructions which, when loaded into the network device 900, may transform it from a general-purpose computing system into a special-purpose computer capable of implementing the embodiments described herein. These computer-executable instructions may be stored as application 922 and transform the network device 900 by specifying how the processor(s) 904 can transition between states, as described above. In some embodiments, the network device 900 has access to computer-readable storage media storing computer-executable instructions which, when executed by the network device 900, perform the various processes described above with regard to FIGS. 1-8. In certain embodiments, the network device 900 can also include computer-readable storage media having instructions stored thereupon for performing any of the other computer-implemented operations described herein.

In many further embodiments, the network device 900 may include a tracking logic 924. The tracking logic 924 can be configured to perform one or more of the various steps, processes, operations, and/or other methods that are described above. Often, the tracking logic 924 can be a set of instructions stored within a non-volatile memory that, when executed by the processor(s)/controller(s) 904 can carry out these steps, etc. In some embodiments, the tracking logic 924 may be a client application that resides on a network-connected device, such as, but not limited to, a server, switch, personal or mobile computing device in a single or distributed arrangement.

In numerous embodiments, the tracking logic 924 may be configured to track one or more virtual network functions hosted on the host device. In order to track the one or more virtual network functions, the tracking logic 924 may generate and transmit one or more tracking requests by modifying one or more input parameters of a hash operation (or algorithm) of the host device. As a result, a tracking response for the one or more tracking requests may be received without routing via multiple network devices of the communication network. Thereby, the tracking response may not be subjected to routing delays. The tracking logic 924 may further use the tracking response to track the one or more virtual network functions. Accordingly, the tracking of the one or more virtual network functions may be performed efficiently without changing the hash algorithm of the host device.

In numerous additional embodiments, the address data 928 may include addresses associated with various network devices of the communication network. For example, the network devices may correspond to the device 900, leaf network devices, and/or spine network devices of the communication network. Additionally, or alternatively, the address data 928 may include addresses associated with host devices of the communication network. As used herein, the addresses may correspond to IP addresses and/or MAC addresses. For example, the IP addresses can include anycast IP addresses and non-anycast IP addresses assigned to different network devices of the communication network.

In a variety of embodiments, the sequence data 930 may include various data sequences generated for transmitting the one or more tracking requests. For example, each data sequence of the data sequences may include a plurality of data parameters. The plurality of data parameters may correspond to input parameters of a hashing algorithm of the host device. The plurality of data parameters may include two or more of a primary source IP address, a destination IP address, a source MAC address, a destination MAC address, a source port number, a destination port number, a communication protocol identifier, etc. As used herein, the data sequences may correspond to tuples, lists, and/or the like. The sequence data 930 may include various data sequences generated while establishing various tracking sessions between the network devices (e.g., the device 900) and the host devices.

In further more embodiments, the timer data 932 may include a response timeout parameter associated with the one or more tracking requests and/or one or more tracking sessions of the one or more tracking requests. Additionally, or alternatively, the tracking logic 924 may update the response timeout parameter to a new response timeout parameter. In this case, the timer data 932 may also include the new response timeout parameter. For example, the response timeout parameter may define the maximum time the tracking logic 924 will wait for a response to a tracking request.

In still further embodiments, the network device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the network device 900 might not include all of the components shown in FIG. 9 and can include other components that are not explicitly shown in FIG. 9 or might utilize an architecture completely different than that shown in FIG. 9.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926.

The ML model(s) 926 can be configured to generate inferences to make predictions or draw conclusions from data. An inference can be considered the output of a process of applying a model to new data. This can occur by learning from at least the address data 928, the sequence data 930, and the timer data 932 and using that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes. Further, the ML model(s) 926 can be utilized to identify an optimal data sequence, e.g., an n-tuple vector, that would result in hashing of a tracking response to a host-side interface of a request transmitting leaf network device.

Although a specific embodiment for a network device 900 suitable for configuration with the tracking logic for carrying out the various steps, processes, methods, and operations described herein is discussed with respect to FIG. 9, any of a variety of systems and/or processes may be utilized in accordance with embodiments of the disclosure. For example, the network device 900 may be in a virtual environment such as a cloud-based network administration suite, or it may be distributed across a variety of network devices or switches. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a network-side interface;
a host-side interface;
a processor; and
a memory communicatively coupled to the processor, wherein the memory comprises a tracking logic that is configured to:
transmit, to a host device via the host-side interface, a first tracking request including a first data sequence;
receive, at the network-side interface, a tracking response for the transmitted first tracking request;
generate one or more second tracking requests based on receiving the tracking response at the network-side interface, wherein each of the one or more second tracking requests includes a second data sequence that is different from the first data sequence; and
transmit the generated one or more second tracking requests to the host device via the host-side interface.

2. The network device of claim 1, wherein the tracking logic is further configured to:
track, based on the first tracking request and the one or more second tracking requests, a virtual network function associated with the host device; and
determine a status of the virtual network function as one of an active state or an inactive state based on the tracking.

3. The network device of claim 2, wherein the virtual network function corresponds to a virtual network forwarder (VNF).

4. The network device of claim 1, wherein the tracking logic is further configured to:
receive, at the host-side interface, a new tracking response for a second tracking request of the one or more second tracking requests; and
designate the second data sequence of the second tracking request as an active data sequence for one or more subsequent tracking requests.

5. The network device of claim 4, wherein the first tracking request and the one or more second tracking requests are associated with a response timeout parameter.

6. The network device of claim 5, wherein the tracking logic is further configured to set a new response timeout parameter for the one or more subsequent tracking requests based on the response timeout parameter.

7. The network device of claim 6, wherein the new response timeout parameter is smaller than the response timeout parameter.

8. The network device of claim 1, wherein the first tracking request and the one or more second tracking requests correspond to bidirectional forwarding detection (BFD) requests.

9. The network device of claim 1, wherein the first data sequence includes a plurality of data parameters, and wherein to generate a second tracking request of the one or more second tracking requests, the tracking logic is further configured to:
sample, from the plurality of data parameters, at least one data parameter based on receiving the tracking response at the network-side interface; and
modify the at least one data parameter to obtain at least one modified data parameter, wherein the second data sequence of the second tracking request includes the at least one modified data parameter.

10. The network device of claim 9, wherein the plurality of data parameters includes two or more of: an internet protocol (IP) address of the network device, an IP address of the host device, a media access control (MAC) address of the network device, or a MAC address of the host device.

11. The network device of claim 1, wherein the host-side interface is communicatively coupled to the host device via a single-hop connection.

12. The network device of claim 1, wherein the network-side interface is communicatively coupled to the host device via a multi-hop connection.

13. The network device of claim 1, wherein the network device is a member of a multi-homing set coupled to the host device.

14. A network device, comprising:
a network-side interface;
a host-side interface;
a processor; and
a memory communicatively coupled to the processor, wherein the memory comprises a tracking logic that is configured to:
establish a first tracking session with a host device, wherein the first tracking session is associated with a first data sequence;
receive, in the first tracking session, a tracking response of the host device at the network-side interface based on the first data sequence; and
establish, based on receiving the tracking response at the network-side interface, a second tracking session with the host device, wherein the second tracking session is associated with one or more second data sequences that are different from the first data sequence.

15. The network device of claim 14, wherein the tracking logic is further configured to:
receive, in the second tracking session, a new tracking response of the host device at the host-side interface; and
designate the second tracking session as an active tracking session based on receiving the new tracking response at the host-side interface.

16. The network device of claim 15, wherein the first tracking session is associated with a response timeout parameter, and wherein the tracking logic is further configured to set a new response timeout parameter for the second tracking session in response to designating the second tracking session as the active tracking session.

17. The network device of claim 16, wherein the new response timeout parameter is smaller than the response timeout parameter.

18. The network device of claim 15, wherein the tracking logic is further configured to deactivate the first tracking session based on the designation of the second tracking session as the active tracking session.

19. The network device of claim 15, wherein the tracking response is received at the network-side interface based on a hash operation on the first data sequence, and wherein the new tracking response is received at the host-side interface based on the hash operation on a second data sequence of the one or more second data sequences.

20. A method, comprising:
in a network device including a host-side interface and a network-side interface:
transmitting, to a host device via the host-side interface, a first tracking request including a first data sequence;
receiving, at the network-side interface, a tracking response for the transmitted first tracking request;
generating one or more second tracking requests based on receiving the tracking response at the network-side interface, wherein each of the one or more second tracking requests includes a second data sequence that is different from the first data sequence; and
transmitting the generated one or more second tracking requests to the host device via the host-side interface.
